(19) United States
(12) Patent Application Publication
(10) Pub. No.: US 2008/0181755 A1
(43) Pub. Date: Jul. 31, 2008

(54) VEHICLE TRANSPORT APPARATUS

(76) Inventor: Dennis E. Harris, Greensboro, NC (US)

Correspondence Address: SMITH MOORE LLP, P.O. BOX 21927, GREENSBORO, NC, 27420, US

(21) Appl. No.: 11/627,717

(22) Filed: Jan. 26, 2007

(51) Int. Cl. B60B 30/10

(52) U.S. Cl. 414/427

(57) ABSTRACT

A portable dolly for use in transporting a vehicle. The dolly includes a base structure that has at least one wheel for rolling the dolly. The dolly also includes at least one lifting arm that is designed to cup the wheel or tire of the vehicle. A lifting mechanism is provided on the dolly for lifting the lifting arm to raise the vehicle's wheel or tire off of the ground surface such that the wheel or tire rests on the lifting arm. The vehicle can then be rolled with the wheel or tire resting on the rolling dolly.

### BACKGROUND OF THE INVENTION

The present invention relates to a dolly for transporting vehicles.

A typical flatbed tow truck, referred to herein as a rollback, is shown in FIG. 1 and identified by 10. Rollback truck operators encounter a common problem when a vehicle is loaded onto a rollback 10 but one or more of the vehicle's wheels does not roll because, for example, the operator does not have the keys to the vehicle and the steering is locked or the wheels are too damaged to roll. In order to slide the locked wheels of the vehicle onto the rollback truck 10, operators use skates 12, as shown in FIG. 2. Particularly, the operator places a skate 12 under the tire 16 on each immobilized wheel of the vehicle 14. In order to get the skate 12 under the tire 16, the operator has to physically knock the skate 12 under the tire 16 until the tire 16 rests on the skate 12, as shown in FIG. 3. This requires a tremendous amount of time and strenuous force from the operator. Once the skate 12 is secured under the tire 16, the vehicle 14 is connected to typical chains that extend from the rollback truck 10. As the chains are wound on the truck 10, they pull the vehicle 14 such that the immobilized wheel slides on the skate 12 onto the rollback truck 10. The skate 12 is also used to unload the vehicle 14 from the rollback truck 10. Often times, the vehicle 14 does not slide off the truck 10 well, even with the skate 12, and the rollback truck 10 has to physically shake the vehicle 14 off the truck 10, which is dangerous for the vehicle 14 and the truck 10.

Another scenario that is encountered is the inability to easily and efficiently transport a vehicle without using the vehicle's drive mechanism, for example, when an operator desires to move the vehicle in a confined space such as a showroom.

Accordingly, there is a need in the art for an improved apparatus and method for transporting a vehicle that is safer, more efficient, and less strenuous.

### BRIEF DESCRIPTION OF THE DRAWINGS

The present invention is better understood by a reading of the Detailed Description of the Invention along with a review of the drawings, in which:

FIG. 1 is a schematic view of a typical rollback truck.

FIG. 2 is a schematic perspective view of a prior art skate.

FIG. 3 is a schematic view of the skate of FIG. 2 loaded under a vehicle tire.

FIG. 4 is a schematic front view of a dolly according to one embodiment of the present invention.

FIG. 5 is a schematic side view of the dolly of FIG. 4 in position to lift a vehicle tire.

FIG. 6 is a schematic view of the dolly of FIG. 4 that is in position to lift a vehicle tire.

FIG. 7 is a schematic view of the dolly of FIG. 4 that has lifted a vehicle tire.

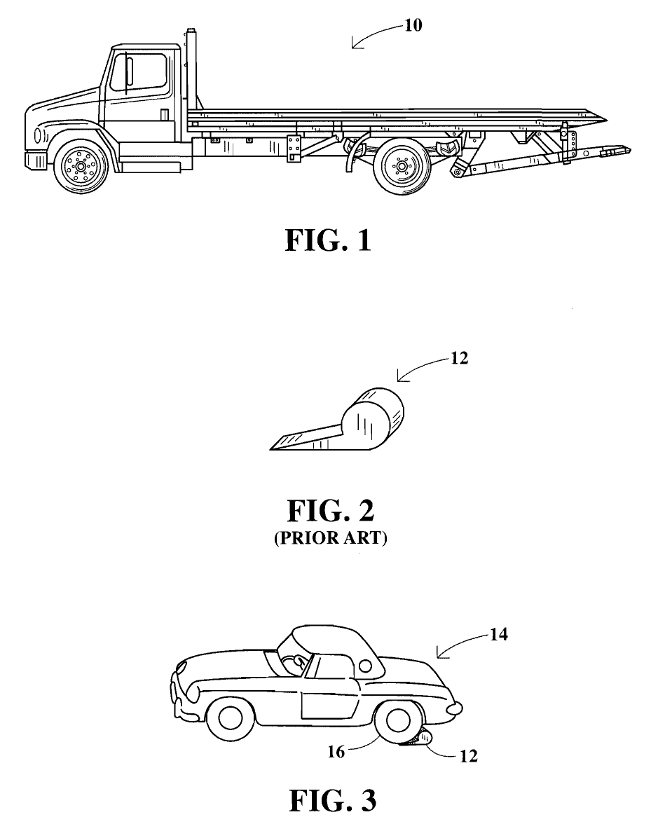

### DETAILED DESCRIPTION OF THE INVENTION

The illustrations and examples discussed in the following description are provided for the purpose of describing the embodiments of the invention and are not intended to limit the invention thereto.

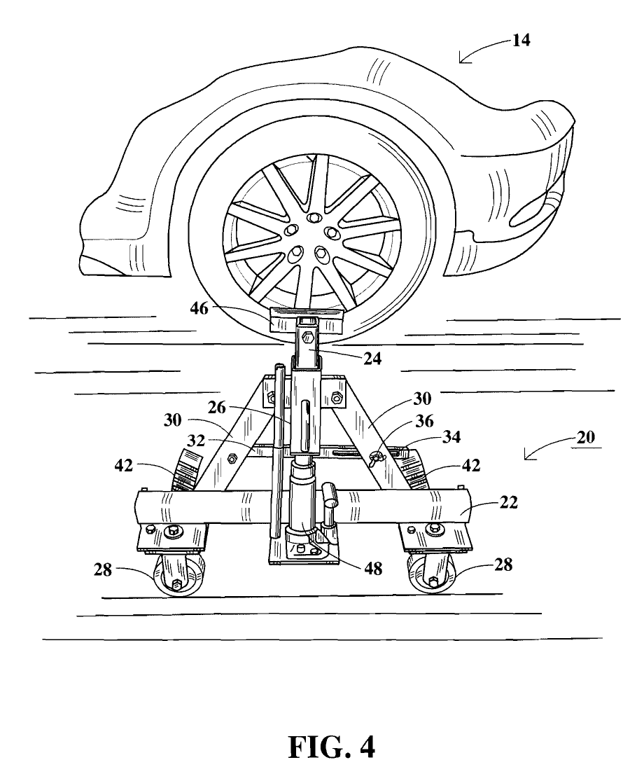

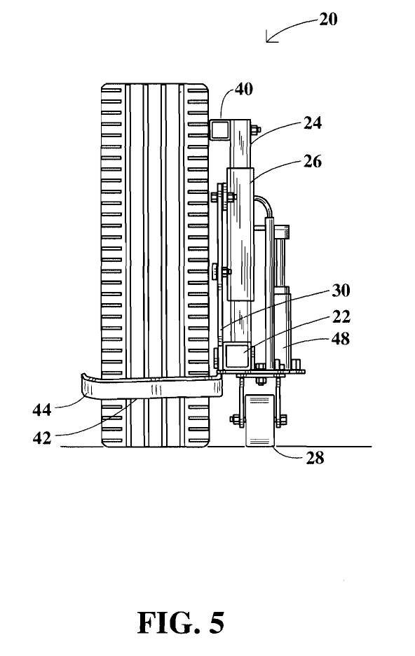

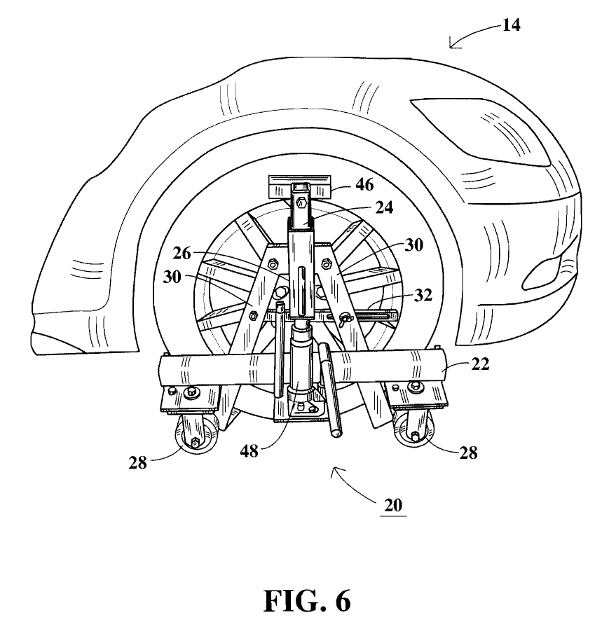

The present invention provides a dolly 20 that enables an operator to more easily and efficiently transport a vehicle. In the embodiment shown in FIGS. 4 through 7, the dolly 20 is used to load a vehicle 14 with an immobilized wheel onto a rollback truck 10. The dolly 20 includes a base structure that may be formed of a lateral bar member 22 and a vertical base bar member 24 that may be substantially perpendicularly connected to the lateral bar member 22. The vertical base bar 24 may be disposed within an adjustable vertical bar member 26 in a sliding engagement. At least one caster or wheel 28 may be disposed on the bottom of each end of the lateral bar 22 for enabling the dolly 20 to be rolled.

The base structure of the dolly 20 may include at least one lifting arm 42 for lifting the immobilized wheel or tire 16 off the ground. In the embodiment shown in FIGS. 4 through 7, the dolly 20 includes two lifting arms 42 that have in-turned ends 44. Each of the lifting arms 42 may be integrally formed with or attached to a respective adjustment member 30. The lifting arms 42 extend away from the adjustment members 30 and may tilt down towards the center of the dolly 20 to cup the wheel or tire 16 of the vehicle 14, as explained further below.

The adjustment members 30 may be connected to either side of the adjustable vertical bar 26 on the rear side of the dolly 20. The adjustment members 30 may extend generally from the top of the adjustable vertical bar 26 towards the outer ends of the lateral bar 22. In one aspect of the invention, each of the adjustment members 30 pivots on an axis in close proximity to the top of the adjustable vertical bar 26 such that the distance between the adjustment members 30 can be adjusted. Particularly, a first crossbar member 32 may be laterally disposed between and connected to the adjustment members 30 and may include an elongated aperture 34 that permits a locking mechanism 36, such as a wing nut, to be inserted through one of the adjustment members 30 and the first crossbar 32 to allow for adjustment of the distance between the adjustment members 30. Once the operator places the adjustment members 30 at the desired positions, the locking mechanism 36 is tightened to secure their position.

A second crossbar 38 may be disposed on the rear side of the lateral bar 22 that is parallel to the lateral bar 22 and forms sidewalls 40 that connect to the ends of the lateral bar 22. The adjustment members 30 may extend through the guide space formed between the lateral bar 22 and second crossbar 38, and the sidewalls 40 provide a wall for when the adjustment members 30 are expanded at the maximum distance apart from one another.

When a vehicle 14 is to be towed and one of the wheels of the vehicle 14 is immobile, the operator prepares the dolly 20 for use by adjusting the positions of the adjustment members 30 such that the maximum amount of distance is between them. The locking mechanism 36 may be tightened to secure this position of the adjustment members 30. The dolly 20 is then rolled into a position such that the dolly 20 is in close proximity to or touching the immobilized wheel or tire 16. The operator releases the locking mechanism 36 so that the lifting arms 42 fall into place to cup the wheel or tire 16. In one embodiment of the invention, a cushion member 46 may be disposed at the top of the vertical base member 24, which is designed to press against the wheel or tire 16 when the dolly 20 is in use. The height of the cushion member 46 on the vertical base member 24 may be adjusted using known methods to accommodate varying wheel and tire 16 sizes. In one aspect, the side of the cushion member 46 that faces the wheel or tire 16 may include a coating formed of rubber or other like materials to avoid scratching or puncturing the tire 16.

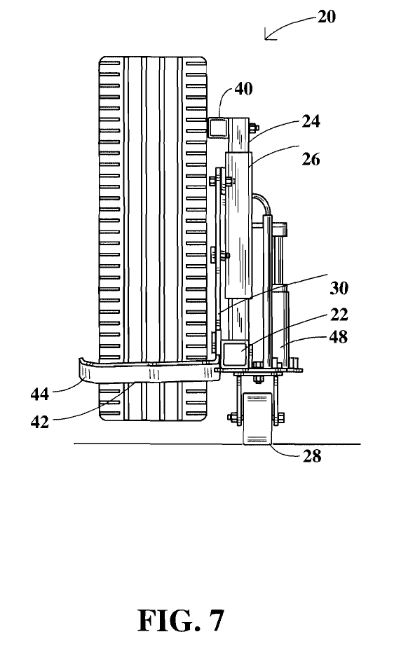

Once the lifting arms 42 are in place cupping the immobilized wheel or tire 16, a lifting mechanism 48 that may be provided on the front side of the dolly 20 may be activated to raise the height of the adjustable vertical bar 26 on the vertical base bar 24. The lifting mechanism 48 as shown in FIGS. 4 through 7 is a known hydraulic jack, however, other known lifting mechanisms may be used including without limitation, pneumatic lifters, electric load lifters, or other mechanical devices that can impart sufficient force to raise the lifting arms 42. When the lifting mechanism 48 raises the height of the adjustable vertical bar 26 on the vertical base bar 24, the adjustment members 30 and corresponding lifting arms 42 are also raised. As shown in FIG. 7, the lifting arms 42 lift the immobilized wheel or tire 16 off of the ground such that the wheel or tire 16 is supported by the lifting arms 42. The vehicle 14 can then be rolled onto the bed of the rollback truck 10 as the immobilized wheel or tire 16 rests on the rolling dolly 20. This process of using a dolly 20 on each immobilized wheel or tire 16 makes it easier for the operator to control the vehicle 14 and is safer for the operator than the prior art method of using skates 12 to slide the immobilized wheel onto the truck 10.

Once the vehicle 14 is winched onto the bed of the rollback 10 and secured for transport, the lifting mechanism 48 on the dolly 20 may be released to lower the wheel or tire 16 back onto the ground surface. The lifting arms 42 can remain under the wheel or tire 16 during transport but would not remain lifted off the ground for safety precautions. When transport is complete, the lifting mechanism 48 is reengaged to lift the wheel or tire 16 and the vehicle 14 is rolled off the bed of the truck 10.

In view of the forgoing, the dolly 20 of the present invention provides tow operators with a more efficient, less strenuous, and safer way to transport a vehicle 14 that has an immobilized wheel. The present invention, however, is not limited to such use. For example, if an operator desires to transport a vehicle 14 but does not want to use the vehicle's 14 drive mechanism or the space in which the vehicle 14 will be moved is limited, the dolly 20 of the present invention may be used to move the vehicle 14. Particularly, the operator engages a dolly 20 at each wheel or tire 16 of the vehicle such that each of the vehicle's 14 wheel or tires 16 are lifted off the ground and resting on a respective dolly 20. The vehicle 14 can then be moved as the weight of the vehicle 14 rests on the dollies 20. Also, the wheels 28 on each of the dollies 20 may be configured to pivot so that the vehicle 14 can be turned 360° on its central axis by rolling on the dolly 20.

Certain modifications and improvements will occur to those skilled in the art upon a reading of the foregoing description. For example, it should be understood that although it is exemplary that the components of the dolly be formed of steel or aluminum, any other rigid and durable material may be used. All such modifications and improvements of the present invention have been deleted herein for the sake of conciseness and readability but are properly within the scope of the following claims.

What is claimed is:

1. A portable dolly for use in transporting a vehicle comprising:
a base structure comprising at least one wheel for rolling the dolly;
at least one lifting arm that extends from the base structure, the lifting arm being configured to cup a wheel or tire on the vehicle; and
a lifting mechanism configured to reversibly move the lifting arm;
wherein when the lifting arm is positioned to cup the wheel or tire and the lifting mechanism is engaged so as to raise the lifting arm, the lifting arm lifts the wheel or tire off the ground such that the wheel or tire rests on the lifting arm and the vehicle can be moved with the wheel or tire resting on the rolling dolly.

2. The dolly of claim 1 wherein the dolly comprises two lifting arms, each said lifting arm being downwardly tilted towards the center of the dolly to cup the wheel or tire of the vehicle.

3. The dolly of claim 2 wherein the end of each lifting arm is turned in towards the center of the dolly cup to assist in cupping the wheel or tire of the vehicle.

4. The dolly of claim 2 wherein the distance between the lifting arms is adjustable to accommodate varying wheel and tire sizes.

5. The dolly of claim 1 wherein the lifting mechanism is a hydraulic jack.

6. The dolly of claim 1 further comprising a cushion member that is connected to the base structure and presses against the wheel or tire of the vehicle when the dolly is in use.

7. The dolly of claim 6 wherein the height of the cushion member on the base structure is adjustable to accommodate varying wheel and tire sizes.

8. The dolly of claim 6 wherein the side of the cushion member that presses against the wheel or tire is coated with a material selected from the group of rubber and the like.

9. A method for transporting a vehicle comprising the steps of:
providing a dolly comprising:
a base structure comprising at least one wheel for rolling the dolly;
at least one lifting arm that extends from the base structure and is configured to cup a wheel or tire on the vehicle; and
a lifting mechanism that is configured to reversibly move the lifting arm;
positioning the dolly adjacent to a wheel or tire on the vehicle;
positioning the lifting arm to cup the wheel or tire;
engaging the lifting mechanism to lift the lifting arm such that the lifting arm lifts the wheel or tire off of the ground and the wheel or tire rests on the lifting arm; and
rolling the vehicle with the wheel or tire resting on the rolling dolly.
